(19) United States
(12) Patent Application Publication
(10) Pub. No.: US 2021/0404234 A1
(43) Pub. Date: Dec. 30, 2021

(54) ROTATIONAL SPRING

(71) Applicant: Tony AWAD, Ottawa (CA)

(72) Inventor: Tony AWAD, Ottawa (CA)

(21) Appl. No.: 17/367,506

(22) Filed: Jul. 5, 2021

Related U.S. Application Data
(63) Continuation-in-part of application No. 16/519,772, filed on Jul. 23, 2019, now Pat. No. 11,053,724.

(51) Int. Cl. E05F 11/32; E05F 11/54

(52) U.S. Cl. CPC E05F 11/32; E05F 11/54; E05Y 2201/68; E05Y 2201/484; E05Y 2900/132

(57) ABSTRACT

There is provided a device to rotationally secure a member with respect to a base. The member is connected to an axle having an ellipse-shaped cross section through an elliptical or truncated-oval cavity for receiving the axle. As the member rotates, different tensions are experienced by the spring based on the orientation of the ellipse-shaped cross section with respect to the orientation of the cavity, thereby providing preferred orientations for the rotating member.

### OTHER APPLICATIONS

This application is a continuation-in-part of application Ser. No. 16/519,772.

### FIELD OF THE DISCLOSURE

The present disclosure relates to a device to join a member to a base while allowing rotation of the member with respect to the base.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

Many devices comprise a rotational connection between different pieces. Further, in many cases, it is advantageous to introduce a bias such that some rotational positions are preferred over others. Accordingly, there is a need for a rotational device joining two different pieces rotationally, that is inexpensive to manufacture, simple to design, and which provides flexibility in providing a bias for different rotational positions.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

The present disclosure is directed to a device comprising: a base comprising a resilient member extending therefrom, the resilient member defining an ellipse-shaped cavity; a rotating member; an axle extending laterally from a proximal end of the rotating member, the axle comprising an ellipse-shaped cross section, the axle passing through the ellipse-shaped cavity.

The present disclosure is further directed to a device comprising: a base; an axle secured to the base, the axle having an ellipse-shaped cross section; a rotating member, the rotating member comprising at a proximate end thereof a pair of members defining a truncated-oval shaped opening; wherein the axle passes through the truncated-oval shaped opening, thereby rotationally securing the rotating member through the base between a first position where a major axis of the ellipse-shaped cross section is perpendicular to rotating member, and a second position where the major axis of the ellipse-shaped cross section is parallel to the rotating member.

The present disclosure is further directed to a device comprising a base; a first shoulder extending upwardly from the base, the first shoulder comprising an ellipse-shaped cavity; a second shoulder extending upwardly from the base, the second shoulder comprising a cavity aligned with the ellipse-shaped cavity of the first shoulder; and an axle extending through the ellipse-shaped cavity and the cavity, the axle comprising a first section with an ellipse-shaped cross-section, wherein the first section is aligned with the ellipse-shape cavity of the first shoulder.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The present disclosure will be better understood having regard to the drawings in which:

FIG. 1 shows a perspective view of a person in a wheelchair closing a door according to the prior art.

FIG. 2 shows a perspective view of a device according to at least one embodiment of the present disclosure.

FIG. 3 shows a perspective view of a person in a wheelchair closing a door using a device according to the present disclosure.

FIG. 4 shows a perspective view of a device according to at least one embodiment of the present disclosure.

FIG. 5A shows a perspective view of a device according to at least one embodiment of the present disclosure.

FIG. 5B shows a perspective view of a device according to at least one embodiment of the present disclosure.

FIG. 6 shows a perspective view of a base of a device according to at least one embodiment of the present disclosure.

FIG. 7 shows a perspective view of a device according to at least one embodiment of the present disclosure.

FIG. 8 shows a perspective view of an arm of a device according to at least one embodiment of the present disclosure.

FIG. 9A shows a side view of a device according to at least one embodiment of the present disclosure.

FIG. 9B shows a side view of a device according to at least one embodiment of the present disclosure.

FIG. 10A shows a rotational spring according to at least one embodiment of the present disclosure in a first position.

FIG. 10B shows a rotational spring according to at least one embodiment of the present disclosure in a second position.

FIG. 10C shows a rotational spring according to at least one embodiment of the present disclosure in a third position.

FIG. 11 shows a rotational spring according to at least one embodiment of the present disclosure.

FIG. 12A shows a base for a rotational spring according to at least one embodiment of the present disclosure.

FIG. 12B shows a rotational spring according to at least one embodiment of the present disclosure.

### DETAILED DESCRIPTION OF THE DRAWINGS

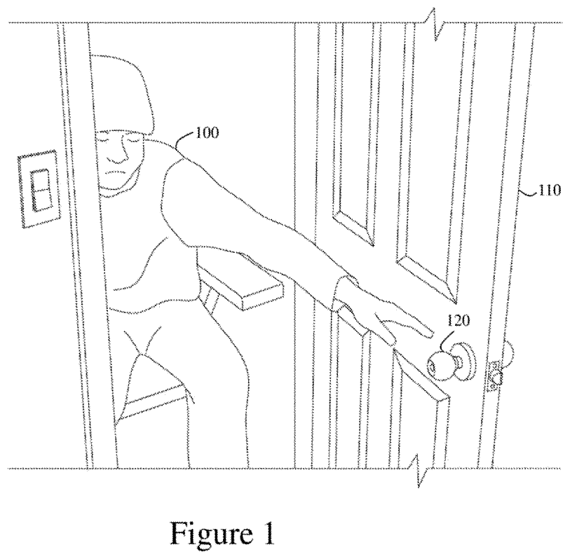

When a person who is in a wheelchair exits a room, it is difficult for them to close the door when the door opens inward. For example, as illustrated in FIG. 1, a person in a wheelchair 100 is exiting a room, and is attempting to close the door 110 behind them. However, the door knob is situated at the farthest possible point on the door, and reaching the door knob 120 can be very difficult, and may even require the person in the wheelchair 100 to position the wheelchair within the room to reach the door knob 120. As the door 110 closes, the person in the wheelchair 100 needs to simultaneously back up through the door frame, while reaching forward to reach door knob 120.

The situation described above occurs a very large number of times in the day to day life of a person in a wheelchair. In some scenarios, the person in the wheelchair may even fall, risking injury or a major inconvenience.

Accordingly, there is a need for an improved method of closing and opening doors for people in wheelchairs.

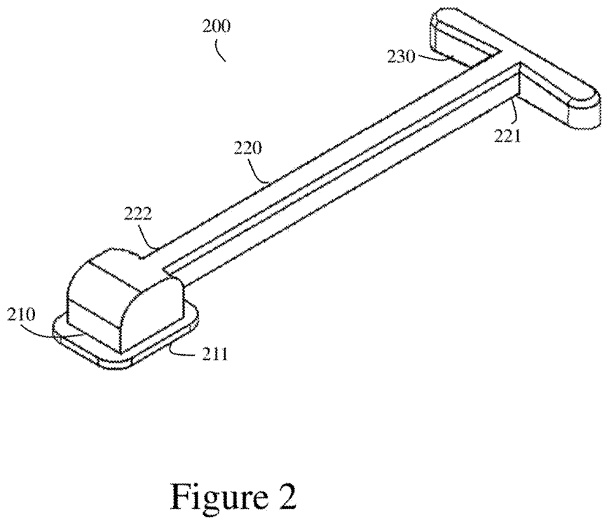

Reference is now made to FIG. 2, which illustrates a device according to a first embodiment of the present disclosure. The device 200 comprises a base 210, an arm 220, and a handle 230. According to at least one embodiment, the base 210 comprises a flat surface 211 for facilitating attachment to a door surface, as will be described in greater detail below. The base 210 may also comprise a pair of holes for allowing screws or other means of securing the device to a door surface.

According to at least one embodiment, the base comprises a flat surface 211 having disposed thereon an adhesive substance. Alternatively, the flat surface 211 may be free of any adhesive substance, and an adhesive substance may be applied to surface 211 at the time of installation.

According to at least another embodiment, device 200 further comprises a separate anchor portion (not shown) comprising means for securing the anchor portion to a door surface. The means for securing the anchor portion to the door surface may include, but are not limited to, holes adapted to receive screws or nails, an adhesive substance, and other securing means known in the art. The anchor portion further comprises means for securing the base 210 of the device 200. For example, the anchor portion may comprise grooves on its internal sides' surfaces designed to cooperate with tongues extending from the side surfaces of the base 210 to secure the base 210 with the anchor portion. However, other means of securing the anchor portion with the base 210 are within the scope of the present disclosure and the present disclosure is not so limited.

Device 200 further comprises an arm 220 extending forwardly from the base 210. According to the embodiment illustrated in FIG. 2, the arm 220 is integrated with the base 210 as a single piece. In this embodiment, the arm 220 is fixed with respect to the base 210. Other embodiments where the arm may pivot relative to the base are discussed below.

As seen in FIG. 2, arm 220 extends in a direction which is parallel to the plane in which surface 211 resides. As will be appreciated, this plane corresponds substantially to the door surface when the device 200 is installed on a door. According to at least some embodiments, the arm 220 is separated from that plane by a sufficient distance to allow a person with a closed first to easily grip or use the arm 220 when device 200 is installed on a door.

In other embodiments, arm 220 may extend in a direction away from surface 211, such that when the device 200 is installed on a door, the distal end 221 of arm 220 is further away from the door surface than proximal end 222. In yet another embodiment, arm 220 extends in a direction towards surface 211, such that when the device 200 is installed on a door, the distal end 221 of arm 220 is closer to the door surface than proximal end 222.

Device 200 further comprises a handle 230 located at distal end 221 of arm 220. The handle may form a T-shape as shown in FIG. 2, but other handle shapes are within the scope of the present disclosure. In at least one embodiment, the handle consists simply of the distal end of arm 220. Handle 230 allows the user to easily grab the device and close the door.

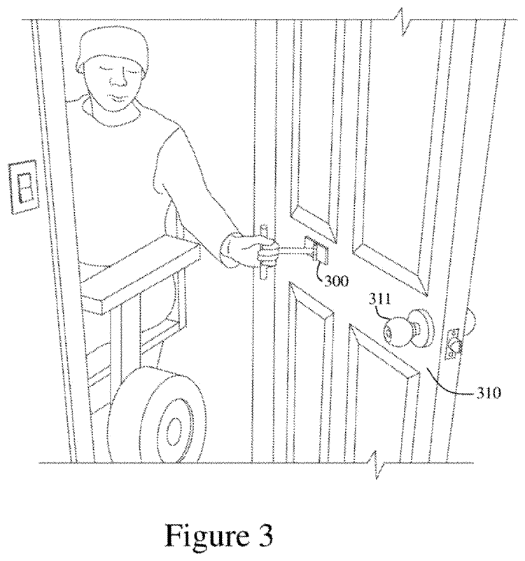

Reference is now made to FIG. 3 which illustrates operation of the device. As can be seen in FIG. 3, the device 300 is installed on an external door surface 310. Typically, the device 300 is installed at a height comparable to the height where a door handle 311 is usually found. However, the device 300 may be installed at any height which is most convenient for the user. As described above, the device 300 may be installed on the door using various means, such as for example a flat surface of the base having an adhesive substance thereon, or by screwing the device to the door through holes provided for that purpose, amongst others.

Furthermore, device 300 is typically installed nearer to the door hinges than the door handle, as is shown in FIG. 3. This allows a person in a wheelchair to grab the device 300 from a position which is outside the door being closed, thereby making it easier for the person in the wheelchair to close the door. In particular, unlike the situation illustrated in FIG. 1, the person in the wheelchair does not need to be within the room to initially reach the door handle, which means that the person does not need to back up as the door is being closed.

While the example illustrated in FIG. 3 shows that the device is installed on an external door surface, the device can also be installed on an internal door surface, especially for doors which swing outwards.

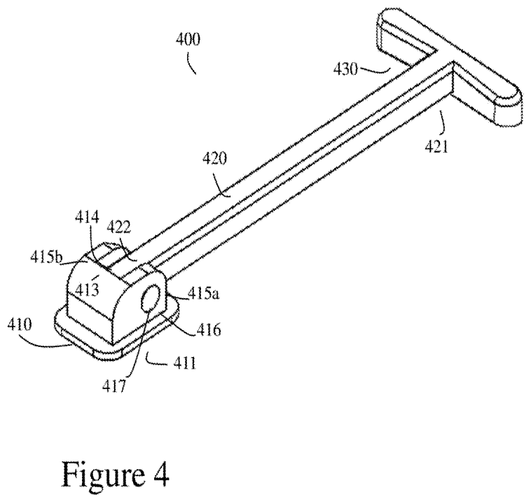

Reference is now made to FIG. 4, which illustrates another embodiment of a device according to at least one embodiment of the present disclosure.

As seen in FIG. 4, device 400 comprise a base 410, an arm 420, and a handle 430.

The base 410 comprises a flat portion 411, for securing the device to a door surface as discussed above. As in the case of the embodiment illustrated in FIG. 2, any means for securing the device to the door surface is within the scope of the present disclosure, including, but not limited to providing an adhesive on flat portion 411, or providing holes to allow screws or nails to secure the base 410 to the door surface.

In this embodiment, the base 410 further comprises a hinge portion 413 for securing arm 420 to the base and for allowing arm 420 to pivot with respect to the base. The hinge portion comprises a cavity 414 for receiving the proximal end of arm 420. On each side of cavity 414 are shoulders 415a and 415b, the edges of which define cavity 414.

Within each shoulder 415a and 415b, bores 416 define a pivoting axis in which pin 417 is received. Specifically, as will be discussed further below, arm 420 comprises a bore (not shown) at its proximal end 421 which has a similar diameter as bores 416. When the proximal end 421 of arm 420 is inserted within cavity 414, bore 422 and bores 416 line up, allowing for pin 417 to be inserted through each of bores 416 and 422.

According to at least one embodiment, pin 417 is sized to fit snuggly within each of bores 416 and 422, such that pin 417 is held into place by friction between its external surface and the internal surface of bores 416 and 422. Bores 416 have a diameter which is slightly smaller than the diameter of bore 422. In one embodiment, the diameter of bores 416 is 0.1 mm smaller than the diameter of bore 422.

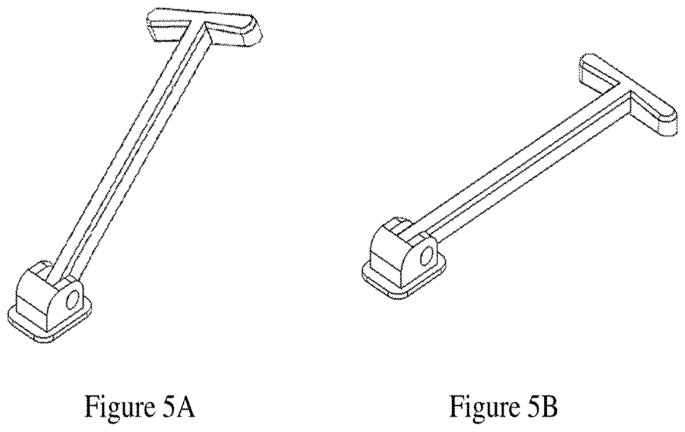

With the arm 420 connected to the base 410 through hinge portion 413, as discussed above, the arm 420 may pivot from a first position shown in FIG. 5A to a second position shown in FIG. 5B.

According to at least one embodiment, arm 420 is sized so that it fits snuggly within cavity 414, such that it remains in place when undisturbed, but can be moved without applying significant force.

According to at least one embodiment, the hinge portion may comprise two parallel rails extending upwardly from the flat portion of the base to define a channel therebetween. Each rail has a bore extending therethrough from an external side surface to an internal side surface for receiving pins extending sideways from a proximal end of the arm. In this embodiment, the arm may be formed from a single piece of metal wire which is bent to form an arm portion, a handle portion, and terminating in two opposite ends bent substantially orthogonally from the arm portion to engage the bore in each rail. Alternatively, the arm may be formed from other material and be equipped, at its proximal end with two opposing pins extending sideways to engage the bore in each rail.

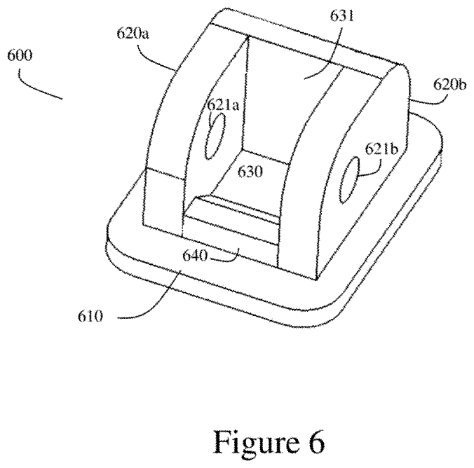

Reference is now made to FIG. 6, which illustrates a base of a device according to yet another embodiment of the present disclosure.

As seen in FIG. 6, base 600 comprise a flat portion 610, and shoulders 620a and 620b.

The base 600 comprises a flat portion 610, for securing the device to a door surface as discussed above. As in the case of the embodiment illustrated in FIG. 2, any means for securing the device to the door surface is within the scope of the present disclosure, including, but not limited to providing an adhesive on the bottom of flat portion 610, or providing holes to allow screws or nails to secure the base 600 to the door surface.

In this embodiment, as in the embodiment illustrated in FIG. 4, the base 600 further comprises a hinge portion 630 for securing an arm to the base 610 and for allowing the arm to pivot with respect to the base. However, unlike the embodiment illustrated in FIG. 4, in the embodiment of FIG. 6, the range of motion of arm is restricted to improve user experience.

Specifically, some people who require the use of a wheelchair have other conditions which may limit their dexterity. In particular, a condition known as “claw hand” may be caused by muscular dystrophy, or other underlying causes, which severely limits the amount of movement in the hands of people who are affected.

For people suffering from claw hand, or other similar conditions, and who also use a wheelchair, it may be difficult to grab the handle of a device of the present disclosure if the handle is resting on the door surface. Specifically, as illustrated in FIG. 5B, the handle may pivot to a position where the handle is touching the door surface. From this position, it may be difficult for some people to engage with the handle and close the door properly.

The embodiment illustrated in FIG. 6 prevents this situation by limiting the range of motion of the arm, as will be described in greater detail below.

Returning now to the embodiment illustrated in FIG. 6, the hinge portion 630 comprises a cavity 631 for receiving the proximal end of the arm. On each side of cavity 631 are shoulders 620a and 620b, the edges of which define cavity 631.

Within each shoulder 620a and 620b, bores 621a and 621b define a pivoting axis in which a pin is received for connecting an arm to the base 600. Specifically, as will be discussed further below, the arm comprises a bore at its proximal end which has a similar diameter as bores 621a and 621b. When the proximal end of the arm is inserted within cavity 631, the bore within the arm and bores 621a and 621b line up, allowing for a pin to be inserted through each of bores 621a, 621b, and the bore within the arm.

According to at least one embodiment, the pin is sized to fit snuggly within each of bores 621a, 621b, and the bore within the arm, such that the pin is held into place by friction between its external surface and the internal surface of bores 621a, 621b, and the bore within the arm.

In the embodiment of FIG. 6, hinge portion 630 further comprises a stop member 640 extending upwardly from flat portion 610. According to at least some embodiments, stop member 640 is located between shoulders 620a and 620b, within cavity 631. During operation, stop member 640 acts to prevent the arm from pivoting to a position where the handle touches the door surface.

According to at least some embodiments, the height of stop member 640, as measured from flat portion 610, is selected such that when the arm is resting on stop member 640, the arm is substantially parallel with flat portion 610. However, other heights are within the scope of the present disclosure, and the present disclosure is not so limited. For example, the height of stop member 640 may be selected such that the arm, when resting on stop member 640, has a distal end which is closer to the door surface (or flat portion 610) than its proximal end. Alternatively, the height of stop member 640 may be selected such that the arm, when resting on stop member 640, has a distal end which is farther away from the door surface (or flat portion 610) than its proximal end.

According to this embodiment, when installed on a door surface, a device comprising a base 600 allows the handle to be grasped easily without needing to separate the handle from the door surface.

With the arm connected to the base 600 through hinge portion 630, as discussed above, the arm may pivot from a first position shown in FIG. 5A to a second position where the arm is closer to the door surface while never touching the door surface.

According to at least one embodiment, the arm is sized so that it fits snuggly within cavity 631, such that it remains in place when undisturbed, but can be moved without applying significant force.

Alternatively, a spacer may be installed on the door at a position aligned with the arm of the device, such that when the arm is moved in a position towards the door, the spacer catches the arm and prevents it from touching the door. This allows space to remain between the handle and the door and allows for easy operation of the device for people lacking the ability to grasp objects with their hands. The spacer may be made of rubber, or any other suitable material.

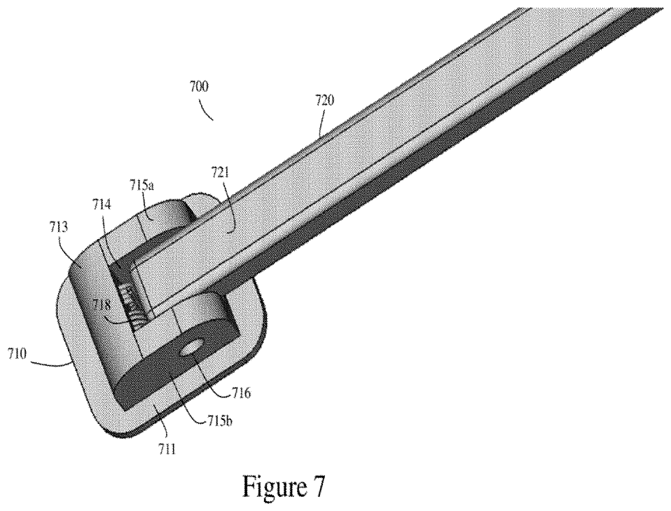

Reference is now made to FIG. 7, which shows another embodiment of the present disclosure, in which the handle is biased towards the door using biasing means.

As seen in FIG. 7, device 700 comprise a base 710, and an arm 720.

The base 710 comprises a flat portion 711, for securing the device to a door surface as discussed above. As in the case of the embodiment illustrated in FIG. 2, any means for securing the device to the door surface is within the scope of the present disclosure, including, but not limited to providing an adhesive on bottom surface of flat portion 711, or providing holes to allow screws or nails to secure the base 710 to the door surface.

In this embodiment, as in the embodiment illustrated in FIG. 4, the base 710 further comprises a hinge portion 713 for securing arm 720 to the base and for allowing arm 720 to pivot with respect to the base. Hinge portion 713 comprises a cavity 714 for receiving the proximal end of arm 720. On each side of cavity 714 are shoulders 715a and 715b, the edges of which define cavity 714.

Within each shoulder 715a and 715b, bores 716 define a pivoting axis in which a pin is received. Arm 720 comprises a bore at its proximal end 721 which has a slightly smaller diameter than bores 716. When the proximal end 721 of arm 720 is inserted within cavity 714, the bore within arm 720 and bores 716 line up, allowing for a pin to be inserted through each of the bores.

According to at least one embodiment, the pin is sized to fit snuggly within the bore of arm 720, such that it is held into place by friction between its external surface and the internal surface of the bore.

The embodiment of FIG. 7 further comprises a double torsion spring 718 within cavity 714, underneath arm 720. Double torsion spring 718 comprises two legs, where each of the two legs extend forwardly from one end of their respective coils. The two separate coils are connected by a middle section which extends forwardly and defines an enclosure shaped to correspond to the cross-section of arm 720. The two legs may be secured to base 710 by pins extending laterally into holes on the internal surface of shoulders 715a and 715b. Arm 720 is secured within cavity 714, over double torsion spring 718, as discussed above, but leaving some room for the coils of double torsion spring 718 behind arm 720, as shown. The middle section of double torsion spring 718 is positioned above arm 720, near proximal end 721.

In operation, when arm 720 is extended away from the door, tension increases within double torsion spring 718. When the arm 720 is released, the tension brings the arm 720 back to a position which is parallel, or nearly parallel, to the surface of the door on which it is used.

Other means of biasing the handle towards the door are within the scope of the present disclosure.

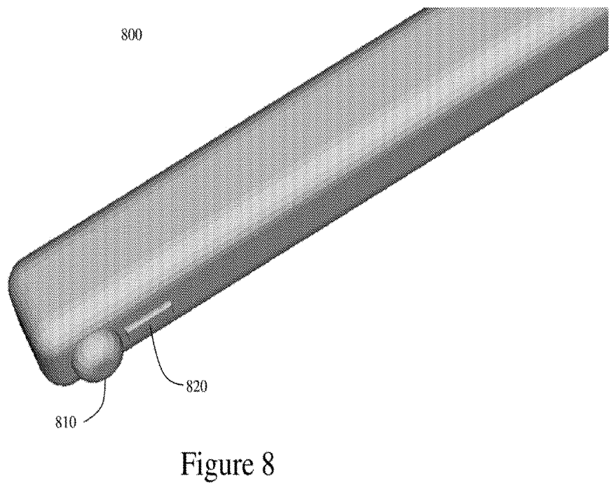

For example, a torsion spring may also be used instead of the double torsion spring shown in the example illustrated in FIG. 7. When a torsion spring is used, the arm of the device may be adapted as shown in FIG. 8.

As shown in FIG. 8, arm 800 comprises a pin 810 extending laterally from a side surface of arm 800, near proximal end of arm 800. Arm 800 further comprises a spring holder extension 820, next to pin 810.

The torsion spring has two legs, extending in opposite directions, with a coil in between. One leg of the torsion spring may be secured to the base, and the coil is placed around pin 810, while the other leg of the torsion spring is secured to spring holder extension 820.

During operation, when the handle is extended away from the door, the tension in the spring increases, and as the handle is released the spring retracts the handle towards the door.

In yet another embodiment, an elastic ring may be provided having one end connected to the base and another end at a point on the lower surface of the arm, such that when the handle is extended away from the door, the tension in the elastic increases, and as the handle is released, the elastic retracts the handle towards the door. The elastic ring may be secured through notches provided on the base and on the lower surface of the arm for that purpose.

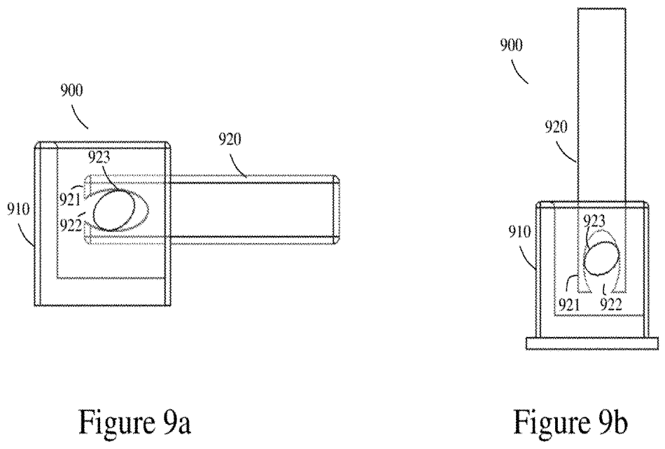

In yet another embodiment, a rotational spring is used. The rotational spring is illustrated in FIG. 9A and FIG. 9B. Specifically, as shown in FIG. 9A, a device 900 includes a base 910, and an arm 920. In this embodiment, the arm 920 is rotationally secured to the base 910 using a novel spring arrangement.

Specifically, as shown in FIG. 9, arm 920 terminates in two members 921 which together create an opening 922. The opening has a generally oval shape, in order to receive internal pin 923, which also has a generally oval cross-section, as shown.

Internal pin 923 is installed such that its cross-section is aligned with the cross-section of opening 922, while the arm 920 is at rest. Internal pin 923 does not rotate with respect to the base 910. For example, in one embodiment, pin 923 is secured to the side walls of base 910.

As seen in FIG. 9A, the arm 920 is positioned such that the internal pin 923 fits within opening 922 without creating any tension in members 921. This allows arm 920 to be secured and at rest in this position.

In FIG. 9B, the arm 920 is positioned 90 degrees from the position shown in FIG. 9A. In this position, the cross section of arm 923 stretches members 921 away from each other, creating tension. According to at least one embodiment, the members 921 and the arm are made from resilient plastic, such that as the arm is rotated to the position shown in FIG. 9B, members 921 are pushed away from each other by internal pin 923. Members 921 being made of resilient material, they naturally exert pressure towards each other as they are pushed away from each other. The more rigid the material, the greater the tension will be created, the more force will be needed to rotate the handle, and the faster the handle will return to its rest position once released. Therefore, when the arm 920 is released, the members 921 apply pressure on internal pin 923, causing the arm 920 to return to its original position shown in FIG. 9A.

Further, as shown in FIG. 9B, internal pin 923 is oriented such that when the arm 920 is fully extended, the arm 920 wont disengage from the internal pin 923. In at least one embodiment, base 910 comprises a stop member (not shown) to prevent the arm 920 from being rotated further than the position shown in FIG. 9B.

Because the cross section of the internal pin 923 is generally oval, as is the cross section of opening 922, the orientation of the opening 922 with respect to internal pin 923 will change the tension between the external surface of internal pin 923 and members 921. Specifically, as the arm 920 rotates, the members 921 will make contact with internal pin 923 at two points which get increasingly further apart from each other. This pushes the members 921 away from each other, thereby creating tension, which is released as the arm 920 is released.

While the embodiment illustrated in FIGS. 9A and 9B comprises the opening 922, some embodiments may omit the opening 922 and instead comprise a surface (now shown) linking both members 921, such that the internal pin is enclosed within the gap defined by members 921. As this may reduce the amount members 921 may move away from each other, rotation of the handle may be restricted as well.

The rotational spring illustrated in FIGS. 9A and 9B could be adapted to different applications than the device to assist in closing doors disclosed herein.

Accordingly, there is provided a rotational spring comprising an axle, the axle having an oval cross section in at least one section, and a rotating member comprising a truncated-oval-shaped opening at one end thereof. The truncated-oval-shaped opening may receive the axle therethrough allowing the member to rotate around the axle. Due to the oval or elliptical cross section of the axle and the truncated oval shape of the opening, rotation is impeded slightly for certain orientations of the member.

Generally, the ellipse-shaped cross section has a major axis and a minor axis, the major axis being the longest axis. When the major axis of the axel cross section is perpendicular to the rotating member, this pushes members 921 away from each other, creating tension and impeding rotation. In contrast when the major axis of the axel cross section is parallel to the rotating member, members 921 are not subject to any tension and arm 920 may rotate freely.

Specifically, as seen in FIG. 9A, the orientation of the pin 923 is such that it does not impede the rotation of the arm 920, because the arm 920 may rotate without creating tension in members 921. However, as seen in FIG. 9B, members 921 are nearly perpendicular to the widest part of pin 923, thereby forcing members 921 away from each other, and creating tension in members 921. The tension in members 921 impedes rotation of the arm 920 when the arm 920 is in such a position.

Rotation may be impeded to different degrees based on the specific application. However, generally it is beneficial to impede rotation to a degree that the arm 920 is stable when untouched, but easily movable by a human hand. The degree to which rotation is impeded is determined from a plurality of factors, including the elasticity of the material used for arm 920, and the difference between the distance between members 921 and the length of the major axis of the cross-section of pin 923.

The opening 922 allows members 921 to move towards or away from each other to accommodate the changing width of pin 923 as arm 923 is rotated.

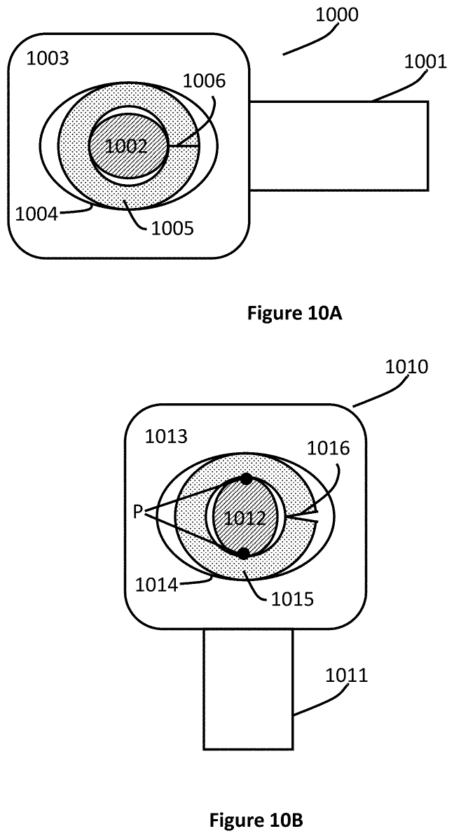

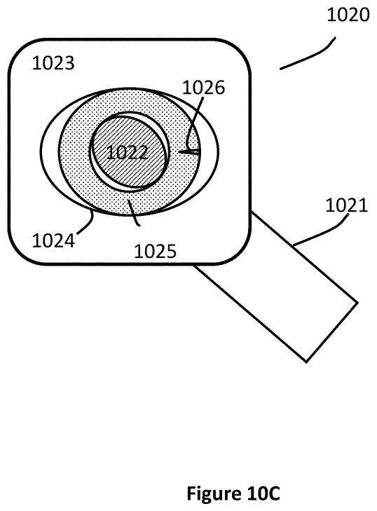

Reference is now made to FIG. 10A, in which a rotational spring according to at least one embodiment of the present disclosure is illustrated.

As seen in FIG. 10A, a rotational spring 1000 comprises a base 1003 which is rotationally coupled to rotating member 1001. Base 1003 may comprise resilient member 1005 which defines an ellipse-shaped cavity for receiving axle 1002. In at least one embodiment, resilient member 1005 is formed with base 1003 as a single piece. Resilient member 1005 is generally ellipse-shaped and is made of resilient material that may be deformed by the rotation of axle 1002 as described below.

Base 1003 may further comprise ellipse-shaped hole 1004, the inner edges of which prevent excessive deformation of resilient member 1005.

Axle 1002 extends from a proximal end of rotating member 1001 which is within base 1003. In the embodiment illustrated in FIG. 10A, the cross section of axle 1002 is shaped like an ellipse.

According to at least some embodiments, resilient member 1005 may be a circle, as long as the cross section of axle 1002 is shaped like an ellipse.

Resilient member 1005 may further comprise a gap 1006, allowing for deformation of resilient member 1005 when force is applied thereto.

When the rotational spring is in a first position as shown in FIG. 10A, the wide part of axle 1002 is aligned with the wide part of resilient member 1005. This creates gaps between axle 1002 and the resilient member 1005, and between the resilient member 1005 and the inner edges of hole 1004. Accordingly, from this position, rotating member 1001 may freely rotate in either direction as no pressure is exerted on it which may prevent it from rotating freely.

Reference is now made to FIG. 10B, which illustrates the same rotational spring with the rotating member in a different position. Specifically, in FIG. 10B, rotating member 1011 is rotationally coupled to base 1013. Base 1013 also comprises cavity 1014 and a resilient member 1015 defining an ellipse-shaped hole for receiving axle 1012. In FIG. 10B, the rotating member 1011 has been rotated 90 degrees and the orientation of axle 1012 has been rotated along with rotating member 1011. Therefore, the cross section of axle 1012 is an ellipse which is not aligned with the ellipse defined by resilient member 1015. In this orientation the axle 1012 is exerting pressure on points P as shown in FIG. 10B.

This pressure deforms resilient member 1015 slightly, as illustrated by gap 1016 which is enlarged with respect to gap 1006 of FIG. 10A. This pressure also inhibits rotation of rotating member 1012 with respect to base 1013.

The amount of pressure which is appropriate may change based on the specific application the rotational spring is used in. Greater pressure may be obtained by increasing the eccentricities of the ellipses for the axle cross section and the resilient member, or by selecting a material for resilient member which is more resistant to deformation, or by making the resilient member thicker. Conversely, lower pressure may be obtained by decreasing the eccentricities of the ellipses for the axle cross section and the resilient member, or by selecting a material for resilient member which is less resistant to deformation, or by making the resilient member thinner.

In at least some embodiments, these factors are selected such that the rotating member 1011 does not move on its own when it is in the position illustrated in FIG. 10B, but can be moved easily with a human hand.

Accordingly, the rotating spring illustrated in FIGS. 10A and 10B provides appropriate resistance to rotation when the rotating member is in certain orientations and very little to no resistance to rotation when the rotating member is in other orientations.

As will be appreciated, the rotating member can be in any position intermediate to the positions illustrated in FIGS. 10A and 10B. One such position is illustrated with respect to FIG. 10C.

In FIG. 10C, the rotational spring 1020 comprises a base 1023, and a rotating member 1021, rotatably coupled to base 1023 with axle 1022 which has an ellipse-shaped cross section. Base 1023 comprises a hole 1024 in which resilient member 1025 is positioned between the axle 1022 and the inner edge of hole 1024.

As shown in FIG. 10C, the rotating member 1021 is rotated at 45 degrees with respect to the position shown in FIG. 10A. As the axle 1022 rotates with the rotating member, the orientation of axle 1022 is also at 45 degrees with respect to the position shown in FIG. 10A. In this position, the pressure exerted on resilient member 1025 by axle 1022 is less than in the position illustrated in FIG. 10B, but greater than in the position illustrated in FIG. 10A.

Generally, the pressure exerted on resilient member is at a minimum when the rotating member is in the position shown at FIG. 10A, and at a maximum when the rotating member is in the position shown at FIG. 10B. The pressure increases as the rotating member is moved from the position shown at FIG. 10A to the position shown at FIG. 10B, and decreases as the rotating member is moved from the position shown at FIG. 10A to the position shown at FIG. 10B.

When only one base is used, the rotating member may rotate 360 degrees. In some embodiments, two opposing bases are used to define a channel in which the rotating member may rotate. In such an embodiment, a member joining the two opposite bases may prevent the complete rotation of the rotating member. However, in other cases, each of the two opposing bases may be supported independently from each other, eliminating the need for a member joining the two opposite bases and allowing for full rotation of the rotating member. In yet other cases, the rotating member may be small enough to rotate within a space between the two opposite bases, and the two opposite bases may be joined by a member outside the rotating space of the rotating member.

The rotational spring illustrated in FIGS. 10A, 10B, and 10C may be modified to allow for a greater number of positions in which rotation of the member is impeded. For example, in one embodiment, the cross section of the axle is ellipse-shaped, but the shape of the hole within the base for receiving the axle may be a rounded triangle or a rounded square. Alternatively, the shape of the hole within the base for receiving the axle may be ellipse-shaped, and the cross section of the axle may be a rounded triangle or a rounded square. These examples are provided for illustrative purposes and are not intended to be limiting.

While the embodiments described herein describe ovals and ellipses, it should be appreciated that such shapes are not intended to be perfect geometrical ellipses or ovals, and that generally elliptical shapes are also suitable for practicing the above-described embodiments.

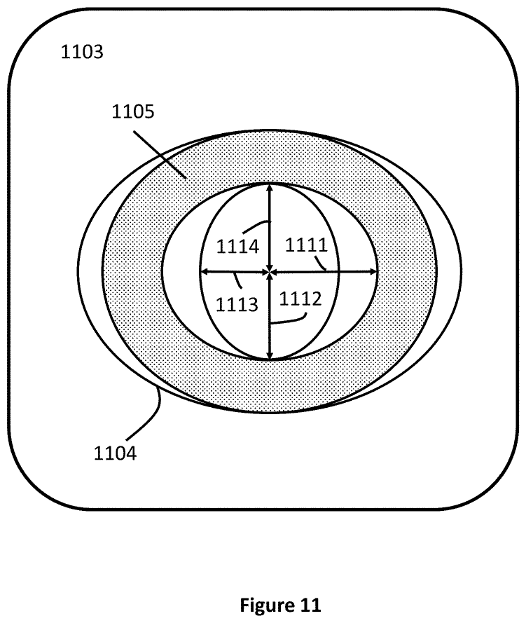

Reference is now made to FIG. 11, in which a base 1103 comprises resilient member 1105 defining an ellipse-shaped cavity for receiving axel 1102. In at least one embodiment, resilient member 1105 may be placed within cavity 1104. Axle 1102 has an ellipse-shaped cross section.

As shown in FIG. 11, the ellipse formed by resilient member 1105 comprises a semi-major axis 1111, and a semi-minor axis 1112. By convention, the semi-major axis is the longest axis and the semi-minor axis is the shortest. The cross-section of axle 1102 comprises a semi-major axis 1114 and a semi-minor axis 1113.

According to at least some embodiments of the present disclosure, the following equation may be used.

Lₘᵢₙₒᵣ(member)−Lₘₐⱼₒᵣ(axle)=λ (1)

With respect to equation (1), Lₘᵢₙₒᵣ(member) represents the length of semi-minor axis of the ellipse defined by resilient member 1105, and Lₘₐⱼₒᵣ(axle) represents the length of semi-major axis of the cross-section of axle 1102. The difference A between Lₘᵢₙₒᵣ(member) and Lₘₐⱼₒᵣ(axle) represents the amount of deformation experienced by member 1105 when axle 1102 is oriented such that the semi-major axis of the cross-section of axle 1102 is parallel and aligned to the semi-minor axis of the ellipse defined by member 1105.

The values of Lₘᵢₙₒᵣ(member), Lₘₐⱼₒᵣ(axle) should be selected so that A represents a desired amount of deformation by resilient member 1105. Specifically, resilient member should be made from a material having an elasticity which allows it to be deformed by A under the appropriate amount of force, as required by the specific application of the rotational spring. Such may include, but are not limited to, various foams and plastics as known by those skilled in the art.

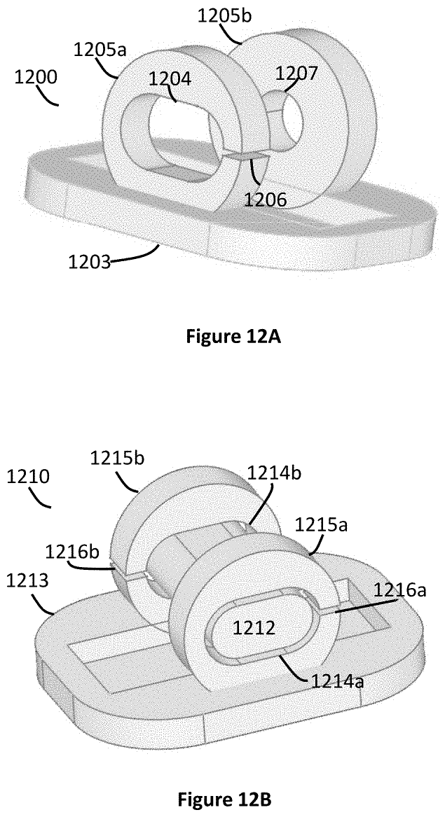

Reference is now made to FIG. 12A. In the embodiment of FIG. 12A, a base 1203 sits perpendicular to a pair of shoulders 1205a and 1205b. In the embodiment shown, shoulders 1205a and 1205b are different. However, in at least some embodiments, both shoulders may be like shoulder 1205a.

According to at least some embodiments, shoulder 1205a is made of resilient material, capable of being deformed slightly when subjected to a force and then returning to its original position when the force is released. Shoulder 1205 may further comprise a gap as shown at 1206, in order to facilitate deformation of shoulder 1205a.

Shoulder 1205a further comprises a generally elliptically shaped cavity 1204. In the embodiment of FIG. 12A, the cavity comprises a straight section and a semi-circular section at each end. However, this is provided merely as an example and is not intended to be limiting.

Shoulder 1205b comprises a circular cavity 1207, aligned with cavity 1204. Cavities 1204 and 1207 cooperate to receive an axle (not shown). The axle may comprise a circular cross section aligned to cavity 1207 and a generally elliptically shaped cross section aligned to cavity 1204. As the axle rotates, the axle cross section's orientation within cavity 1204 will result in the deformation of the material of shoulder 1205a, thereby inhibiting rotation of the axle.

Again, the extent to which rotation of the axle is inhibited for certain orientations of the axle's cross section within cavity 1204 is determined by a number of factors including the elastic properties of the material of shoulder 1205a, and the amount of deformation of the material caused by the rotation of the axle. In general, the difference between the major axis of the axle's cross section and the minor axis of cavity 1204 is proportional to an amount of maximum deformation experienced by shoulder 1205a.

An example of a generally elliptically shaped cross section for the axle is shown at FIG. 12B.

Specifically, as seen in FIG. 12B a rotational spring 1210 comprises a base 1213 and a pair of opposing shoulders 1215a and 1215b. Each shoulder 1215a and 1215b comprises a corresponding ellipse-shaped cavity 1214a and 1214b for receiving an axle 1212. Shoulders 1215a and 1215b are made of resilient material and comprise a gap 1216a and 1216b for facilitating deformation of the shoulders during rotation of axle 1212.

According to at least some embodiments of the present disclosure, gaps 1216a and 1216b are at opposing sides, as seen in FIG. 12B.

Axle 1212 comprises an ellipse-shaped cross section such that when axle 1212 is oriented as seen in FIG. 12B, axle 1212 fits within cavities 1214a and 1214b without imparting any tension on shoulders 1215a and 1215b. However, when axle 1212 is rotated from the orientation seen in FIG. 12B, axle 1212 starts to deform shoulders 1215a and 1215b slightly, thereby creating tension and inhibiting rotation of the axle 1212. When axle 1212 reaches a position of maximum deformation of shoulders 1215a and 1215b, 90 degrees from the position seen in FIG. 12B, rotation of the axle 1212 is maximally inhibited. In at least one embodiment, rotation of the axle is inhibited to a degree such that the axle is stable, but can be rotated easily by a human hand.

As seen in FIG. 12B the axle 1212 terminates at shoulders 1215a and 1215b, however in other embodiments the axle may extend beyond shoulders 1215a and 1215b and be connected to a handle, or an electric motor, amongst other options.

A rotational spring according to the present disclosure may be used for a number of applications. In one application, the rotational spring of the present disclosure is used in a device to assist in opening doors as described herein. Generally, the rotational spring according to the present disclosure may be used to join a rotating member to a base while biasing the rotating member to certain orientations.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

Moreover, the previous detailed description is provided to enable any person skilled in the art to make or use the present invention. Various modifications to those embodiments will be readily apparent to those skilled in the art, and the generic principles defined herein may be applied to other embodiments without departing from the spirit or scope of the invention described herein. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. A device comprising:
a base comprising a resilient member extending therefrom, the resilient member defining an ellipse-shaped cavity;
a rotating member;
an axle extending laterally from a proximal end of the rotating member, the axle comprising an ellipse-shaped cross section, the axle passing through the ellipse-shaped cavity.

2. The device of claim 1, wherein the resilient member comprises a gap.

3. The device of claim 1, comprising a second resilient member defining a second ellipse-shaped cavity opposite the ellipse-shaped cavity, the axle passing through the second ellipse-shaped cavity.

4. A device comprising:
a base;
an axle secured to the base, the axle having an ellipse-shaped cross section;
a rotating member, the rotating member comprising at a proximate end thereof a pair of members defining a truncated-oval shaped opening;
wherein the axle passes through the truncated-oval shaped opening, thereby rotationally securing the rotating member through the base between a first position where a major axis of the ellipse-shaped cross section is perpendicular to rotating member, and a second position where the major axis of the ellipse-shaped cross section is parallel to the rotating member.

5. A device comprising:
a base;
a first shoulder extending upwardly from the base, the first shoulder comprising an ellipse-shaped cavity;
a second shoulder extending upwardly from the base, the second shoulder comprising a cavity aligned with the ellipse-shaped cavity of the first shoulder; and
an axle extending through the ellipse-shaped cavity and the cavity, the axle comprising a first section with an ellipse-shaped cross-section, wherein the first section is aligned with the ellipse-shape cavity of the first shoulder.

6. A device according to claim 5, wherein the cavity of the second shoulder is a second ellipse-shaped cavity, and wherein the first section extends to the second ellipse-shaped cavity.

7. A device according to claim 6, wherein the first shoulder comprises a first gap and the second shoulder comprises a second gap.

8. A device according to claim 7 wherein the first gap and the second gap are at opposite sides of the base.
